(19) United States
(12) Patent Application Publication
(10) Pub. No.: US 2005/0081428 A1
(43) Pub. Date: Apr. 21, 2005

(54) Method for controlling mosquito reproduction

(76) Inventors: Bruce R. Ramsey, Norton, OH (US); Barbara Ramsey, Norton, OH (US)

Correspondence Address: HAHN LOESER & PARKS, LLP, One GOJO Plaza, Suite 300, AKRON, OH, 44311-1076, US

(21) Appl. No.: 10/901,487

(22) Filed: Jul. 27, 2004

Related U.S. Application Data
(60) Provisional application No. 60/511,235, filed on Oct. 15, 2003.

(51) Int. Cl. A01M 1/20; A01M 1/02

(52) U.S. Cl. 43/132.1

(57) ABSTRACT

A method for controlling mosquito populations comprising the following steps: a) providing an insecticide comprising a pyrethroid, b) providing a sprayer having an extension thereon, c) inserting the insecticide into the sprayer, d) inserting the extension into the catch basin, e) spraying the insecticide onto the interior surfaces of the catch basin, including any stagnant water which may be located at the drop-off of the catch basin.

This application claims the benefit of U.S. provisional patent application Ser. No. 60/511,235, filed Oct. 15, 2003, and hereby incorporated by reference.

### TECHNICAL FIELD

The present invention relates to a method and system for controlling mosquito reproduction and, more particularly, to a method and system for applying a pyrethroid based insecticide agent within individual catch basins of an urban/suburban catch basin system, which kills mosquitoes with a single annual application in an effort to prevent the spread of the West Nile virus in urban/suburban communities.

### BACKGROUND OF THE INVENTION

The West Nile virus is a mosquito-borne disease that can cause encephalitis, meningitis, and flu-like illnesses. The West Nile virus survives by circulating between the bird and mosquito population. The West Nile virus is spread to humans by the bite of an infected mosquito, primarily of the species Culex pipiens, also known as the Northern house mosquito, but also including other mosquito species to a lesser degree. These mosquitoes live primarily in urban and suburban communities, where man-made basins of stagnant water are readily available. Sources of stagnant water include ditches, storm catch basins, dismounted tires, children's toys left in the yard, etc. These bodies of stagnant water provide breeding grounds for the mosquitoes that spread the West Nile Virus. The West Nile virus was first identified in North America in 1999. In 2002, there were over 4000 cases and 250 deaths in North America attributed to the West Nile virus, although it is likely that these numbers are under reported due to the fact that many infected people exhibit only flu-like symptoms. The West Nile virus also affects dogs, cats, and horses, as well as other livestock. Birds, such as crows, experience the disease more severely and usually die. Accordingly, surveillance and testing of dead crows is commonly used as an indicator of virus activity in a geographical area.

With the proliferation of the West Nile virus, the disease remains a serious concern for communities throughout North America. Accordingly, many communities have instituted multi-tiered programs directed at preventing the spread of the West Nile virus. These programs include educating the public to reduce personal mosquito exposure, surveillance of bird deaths caused by exposure to the West Nile virus, and controlling mosquito populations by using nonchemical methods, and chemical methods such as larvicides and insecticides.

Mosquitoes have four stages of development which are (in order): egg, larva, pupa, and adult. Mosquitoes lay their eggs either on water or on soils that are periodically flooded. One of the most significant man-made breeding areas for mosquitoes that carry the West Nile virus is the storm catch basin. A catch basin typically includes a curb inlet or grate inlet where storm water enters the basin to capture sediment and organic debris. Storm catch basins are plentiful in both urban and suburban communities ranging in number from tens of thousands to hundreds of thousands. Storm catch basins often have standing water located in the drop-off area between drain pipes connected at the storm catch basin which provides the perfect breeding area for mosquitoes such as Culex pipiens.

Urban and suburban communities are currently developing programs to stop mosquitoes from breeding in catch basins. Methods the prevention have included periodically vacuuming the stagnant water, silt, and debris from the catch basin; flushing the catch basin periodically; and/or periodically injecting steam into the catch basin. However, each of these methods must be repeated after every rainfall making them time-consuming and costly. One of the most widespread prevention methods is the use of a larvicide called methoprene. Capsules or tablets containing methoprene are dropped into the stagnant water at the bottom of the catch basin. The methoprene kills the mosquito larva. While methoprene has been found to be an effective in reducing mosquito larva, it has several drawbacks which reduce its overall effectiveness. One problem with methoprene is that it has an effective life of only 20 to 30 days and must be reapplied throughout the season. Another problem is that the capsules are relatively expensive, especially when multiplied by the number of storm catch basins a community may have. In order to reduce costs, community health agencies have attempted to predict when application of the larvicide may be most effective depending on rainfall and temperature during the mosquito season. All of these problems may result in times where the catch basin may be unprotected and allow reproduction of the mosquito, especially considering that it may take only seven days for larvae to become adult mosquitoes.

More traditional methods of killing adult mosquitoes have also been employed such as aerial spraying or fogging of communities with chemicals such as malathion. The spraying of chemicals in communities has come under great resistance from environmental and health groups. Accordingly communities have included aerial spraying as a method of last resort in their West Nile virus mosquito control programs.

For at least the following reasons there remains a needed in the art for an effective method of preventing mosquito reproduction in catch basins and other locations of standing water.

### SUMMARY OF THE INVENTION

An advantage of the present invention is that it provides a method and system for a onetime application of a pyrethroid-based insecticide which kills mosquitoes in all lifecycle stages. These and other advantages are provided by a method for controlling mosquito populations comprising the following steps: a) providing an insecticide comprising a pyrethroid, b) providing a sprayer having an extension thereon, c) inserting the insecticide into the sprayer, d) inserting the extension into the catch basin, e) spraying the insecticide onto the interior surfaces of the catch basin, including any stagnant water which may be located at the drop-off of the catch basin.

These and other advantages are also provided by a method for controlling mosquito populations comprising the following steps: a) providing an latex paint having an insecticide ingredient comprising a pyrethroid of Permethrin or Deltamethrin, and b) applying the latex paint having insecticide onto the interior surfaces of a catch basin, including any stagnant water which may be located at a drop-off of the catch basin.

These and other advantages will be apparent by reviewing the following specification and drawings.

### BRIEF DESCRIPTION OF THE DRAWINGS

FIG. 1 shows a cross-sectional view of a storm catch basin; and

FIG. 2 shows a partial cross-sectional view of the combination storm catch basin of FIG. 1 and an applicator applying an insecticide containing pyrethroid to the interior surfaces of the catch basin.

### DETAILED DESCRIPTION OF THE INVENTION

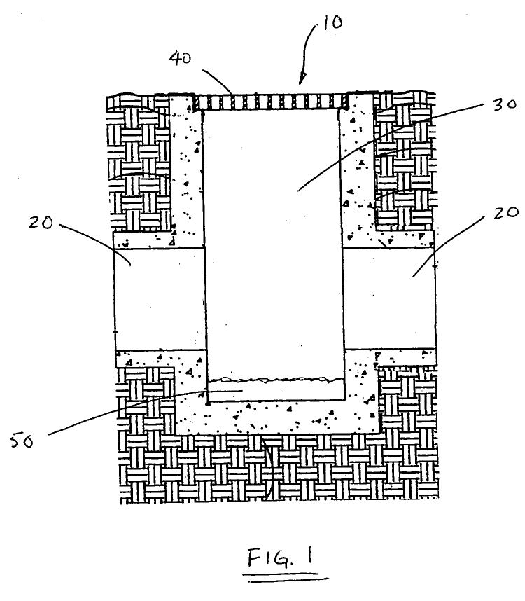

Referring to FIG. 1, a cross-sectional view of a storm catch basin 10 is shown. The storm catch basin 10 comprises one or more inlet/outlet pipes 20, a basin chamber 30, a grate 40, and a drop off area 50 below the ends of the pipes 20, resulting in a stagnant water filled basin 50 located below the level of the pipes 20.

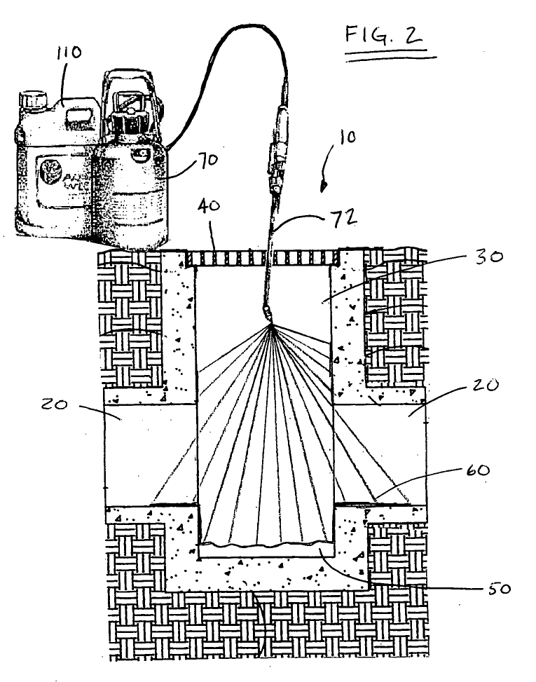

As shown in FIG. 2, a trained technician (not shown) applies a spray coat 60 of insecticide 110 to the interior of the storm catch basin 10 by using a sprayer 70 with an extension 72. The extension 72 is placed through the grate 40 and the sprayer 70 is used to spray a pyrethroid based insecticide 110 to the interior surfaces of the catch basin 10. The pyrethroid based insecticide 110 has a long residual period. One benefit of a pyrethroid based insecticide 110 with a long residual period is that, after the insecticidal coating is applied, it will remain effective for a long period and only needs to be reapplied to the surface approximately once per season or once per year. One such pyrethroid based insecticidal coating is sold under the trademark INSECTA®. The INSECTA® liquid product contains Permethrin (2%) as an active ingredient. Permethrin is a pyrethroid insecticide, which has been widely used, impregnated in mosquito netting to control mosquitoes. The Permethrin impregnated mosquito nets have the ability to remain effective in killing mosquitoes even after repeated washing of the nets and over a significant period of time of over two years.

While Permethrin is provided in a first embodiment of the method of the present invention, it is contemplated that other synthetic pyrethroid insecticides may also be suitable, such as Deltamethrin. In addition, more than 1,000 pyrethroids have been developed, and it is believed that other synthetic pyrethroids may be suitable in the present invention and are contemplated herein.

The pyrethroid insecticidal coating used in one embodiment is in a clear liquid form. However, it is also contemplated that the insecticidal coating can be applied in a latex paint. The latex paint is white in liquid form and dries to a clear coat. This method of application makes the initial coverage area more visible and also avoids broadcasting the insecticidal substance to surrounding areas.

The pyrethroid insecticide 110 is applied to the basin chamber walls 30 of the catch basin 10, including the ends of the pipes 20, and the stagnant water located in the drop-off area 50 (or to the bottom of the drop-off area 50 if there is no water present). The pyrethroid insecticide 110 will dry on the dry surfaces 20, 30 where it will kill any mosquitoes that come into contact with the treated surfaces. Mosquitoes generally like to congregate near bodies of water and will land on adjacent surfaces. Mosquitoes congregating in the basin will land on the treated dry surfaces and will be killed by the exposure to the pyrethroid insecticide 110. Some of the insecticide will land in the water during the spraying application. The waterbome pyrethroid insecticide 110 will act as a larvicide within the stagnant water. Any larva in the water or mosquito eggs deposited in the water in the drop off area will be killed by the exposure to the pyrethroid insecticide 110 in the stagnant water. Accordingly, the pyrethroid insecticide 110 will work both as a larvicide and an insecticide. Throughout the season, the pyrethroid insecticide 110 in the stagnant water may have its effectivity reduced by the water running through the storm sewer systems. Young mosquitoes that attempt to emerge from the stagnant water in the treated catch basin 10 will be killed by the exposure to the pyrethroid insecticide 110 remaining on the surfaces of the catch basin 10. The longevity of the pyrethroid insecticide 110 will enable the treated surfaces to effectively kill mosquitoes for an entire season, or year, regardless of the amount of water moving through the storm system in a given season.

The effectiveness of the method and system of the present invention will provide communities a significant deterrent to the spread of the West Nile virus. The method and system of the present invention will allow urban/suburban communities to rely less on, or even possibly eliminate, other prevention techniques such as aerial spraying of communities with chemicals such as malathion. The present invention has the potential to effectively control the spread of the West Nile virus in urban and suburban communities when integrated into a comprehensive plan of source reduction and public education. The present invention is a substantially lower cost alternative and can save individual communities millions of dollars in the ongoing battle against the mosquitoes that carry the West Nile virus.

1. A method for controlling mosquito populations comprising the following steps:
a) providing an insecticide comprising a pyrethroid,
b) providing a sprayer having an extension thereon,
c) inserting the insecticide into the sprayer,
d) inserting the extension into the catch basin,
e) spraying the insecticide onto the interior surfaces of the catch basin, including any stagnant water which may be located at the drop-off of the catch basin.

2. The method as recited in claim 1, wherein the insecticide comprises Permethrin.

3. The method as recited in claim 1, wherein the insecticide comprises Deltamethrin.

4. The method as recited in claim 1, wherein the insecticide is provided within a paint.

5. The method as recited in claim 1, wherein the interior surfaces of the catch basin include all catch basin walls.

6. The method as recited in claim 1, wherein the interior surfaces of the catch basin include a drop-off area.

7. The method as recited in claim 1, wherein the interior surfaces of the catch basin include water in the drop-off area.

8. The method as recited in claim 1, wherein the interior surfaces of the catch basin include an inlet pipe.

9. The method as recited in claim 1, wherein the interior surfaces of the catch basin include an outlet pipe.

10. The method as recited in claim 1, wherein the interior surfaces of the catch basin include the grate.

11. A method for controlling mosquito populations comprising the following steps:
a) providing an latex paint having an insecticide ingredient comprising a pyrethroid of Permethrin or Deltamethrin, and
b) applying the latex paint having insecticide onto the interior surfaces of a catch basin, including any stagnant water which may be located at a drop-off of the catch basin.

12. A method for controlling mosquito populations in a community having a plurality of catch basins, comprising the following steps:
a) providing an insecticide comprising a pyrethroid,
b) providing a regulatory qualified person trained in applying the insecticide,
c) having the qualified person spray the insecticide onto the interior surfaces of the catch basin, including any stagnant water which may be located at the drop-off of the catch basin, and
d) repeating steps a-c on an annual basis for at least one other catch basin of the plurality of catch basins.

13. The method as recited in claim 13, wherein the insecticide comprises Permethrin.

14. The method as recited in claim 13, wherein the insecticide comprises Deltamethrin.

15. The method as recited in claim 13, wherein the insecticide is provided within a paint.

16. The method as recited in claim 1, wherein the interior surfaces of the catch basin include all catch basin walls.
